(19) United States
(12) Patent Application Publication
(10) Pub. No.: US 2013/0282509 A1
(43) Pub. Date: Oct. 24, 2013

(54) SALES LEAD GENERATION SYSTEM FOR A COMPANY IN A SERVICE INDUSTRY AND RELATED METHODS

(71) Applicants: Warren G. Strong, Salt Lake City, UT (US); Cody T. Ahlquist, West Valley City, UT (US); Shawn A. Hall, Salt Lake City, UT (US)

(72) Inventors: Warren G. Strong, Salt Lake City, UT (US); Cody T. Ahlquist, West Valley City, UT (US); Shawn A. Hall, Salt Lake City, UT (US)

(73) Assignee: YOUNG ELECTRIC SIGN COMPANY, Salt Lake City, UT (US)

(21) Appl. No.: 13/454,338

(22) Filed: Apr. 24, 2012

(51) Int. Cl. G06Q 30/00; G06Q 10/00

(52) U.S. Cl. 705/26.4; 705/302

(57) ABSTRACT

A sales lead generation system for a company in a service industry is disclosed. The sales lead generation system may comprise a master database for storing information for customers of the company, and a mobile device for communicating sales lead information for service work to the master database. The sales lead information may include identifying information for the customers and at least one media file indicating an anomaly condition at a location of the customer. A related method and computer-readable medium are also disclosed.

### FIELD

The present disclosure relates generally to generating sales leads for a company in a service industry, and more specifically, to detecting an anomaly at a location and transmitting information relating to the anomaly for a recommendation for performing a service to remedy the anomaly.

### BACKGROUND

The sign industry (e.g., displays, signs, display boards, advertising displays, etc.) has existed to convey information to a passerby such as advertising, traffic messages, and the like. Signs may be a permanently fixed structure, such as a stationary roadside billboard, while other signs may be attached to a mobile structure such as a bus, train, automobile, and other types of vehicles. Traditionally these signs were only capable of delivering a single message or advertisement. This message was generally in a printed medium that was adhered to the sign. To change the message, new paper needed to be printed and adhered to the sign. More recently, signs have become electronic, using lights, light-emitting diodes (LEDs), and other electronic devices to display visual content that can be easily adaptable to display a wide variety of messages in the form of words and images from the same sign without having to physically change the characteristics of the sign. These electronic signs can easily modify a graphic image or message to create video displays and modify the type of message or advertisement that is shown on the electronic board at regular intervals, or at targeted times depending on expected traffic near the sign, or public interest.

Signs, such as billboards, electronic displays, etc., may experience an anomaly condition, for which servicing the signs may be desirable. For example, a portion of the electronic display may be non-operational, such as having an electrical short or other outage in the electronics or lighting elements. Other anomaly conditions may include needing a paint touch up, or other maintenance to the physical structure of the electronic display. Such anomalies may be remedied by a sign servicing company. Other anomaly conditions may be identified in other industries, and which may be remedied by a servicing company in that particular industry.

### BRIEF DESCRIPTION OF THE DRAWINGS

FIG. 1 is a schematic block diagram of a sales lead generation system for generating, organizing, and managing sales leads for service contracts and other related information according to an embodiment of the present disclosure;

FIG. 2 is a flowchart illustrating a method for generating a sales lead for a company in a service industry according to an embodiment of the present disclosure;

FIG. 3 is a flowchart illustrating a method for generating a sales lead for a company in a service industry according to an embodiment of the present disclosure;

FIGS. 4 through 14 show a variety of graphical user interfaces (GUIs) that may be employed for accessing and organizing information stored in the master database of FIG. 1 according to an embodiment of the present disclosure;

FIGS. 15 through 20 show a variety of GUIs that may be employed for operating the mobile device of FIG. 1 according to an embodiment of the present disclosure; and

FIGS. 21 through 25 show a variety of GUIs that may be employed for operating the mobile device of FIG. 1 according to an embodiment of the present disclosure.

### DETAILED DESCRIPTION

In the following detailed description, reference is made to the accompanying drawings which form a part hereof, and in which is shown by way of illustration specific embodiments of the present disclosure. These embodiments are described with specific details to clearly describe the embodiments of the present disclosure. However, the description and the specific examples, while indicating examples of embodiments of the present disclosure, are given by way of illustration only and not by way of limitation. Other embodiments may be utilized and changes may be made without departing from the scope of the disclosure. Various substitutions, modifications, additions, rearrangements, or combinations thereof may be made and will become apparent to those of ordinary skill in the art. In addition, features from one embodiment may be combined with features of another embodiment while still being encompassed within the scope of the disclosure as contemplated by the inventors.

Referring in general to the following description and accompanying drawings, various embodiments are illustrated to show their structure and method of operation. Common elements of the illustrated embodiments may be designated with similar reference numerals. It should be understood that the figures presented are not meant to be illustrative of actual views of any particular portion of an actual structure or method, but are merely idealized representations employed to more clearly and fully depict the embodiments of the present disclosure. It is to be understood that other embodiments may be utilized, and that structural, logical, and electrical changes may be made within the scope of the disclosure.

The various illustrative logical blocks, modules, and circuits described in connection with the embodiments disclosed herein may be implemented or performed with a processor such as a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor executes instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration.

Also, it is noted that the embodiments may be described in terms of a process that may be depicted as a flowchart, a flow diagram, a structure diagram, or a block diagram. Although a process may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on computer-readable media. Computer-readable media includes both computer storage media and communication media, including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. A reference to first and second elements does not mean that only two elements may be employed there or that the first element must precede the second element in some manner. Also, unless stated otherwise a set of elements may comprise one or more elements.

Embodiments of the present disclosure relate to systems and methods for servicing companies to generate, organize, and follow up on sales leads related to their service industry, which may result in increased business revenue and maintaining existing customer satisfaction. In an industry such as the sign industry, a servicing company may be an independent sign servicing company, a sign manufacturing company that also performs servicing, or another entity that is associated with the servicing or manufacturing company (e.g., an agent, a franchisee, etc.). For example, a franchisor may act in a centralized role in managing sales leads, such as in generating, organizing, and following up with sales leads. The franchisor may also coordinate the efforts of a franchisee that executes the job and performs the service.

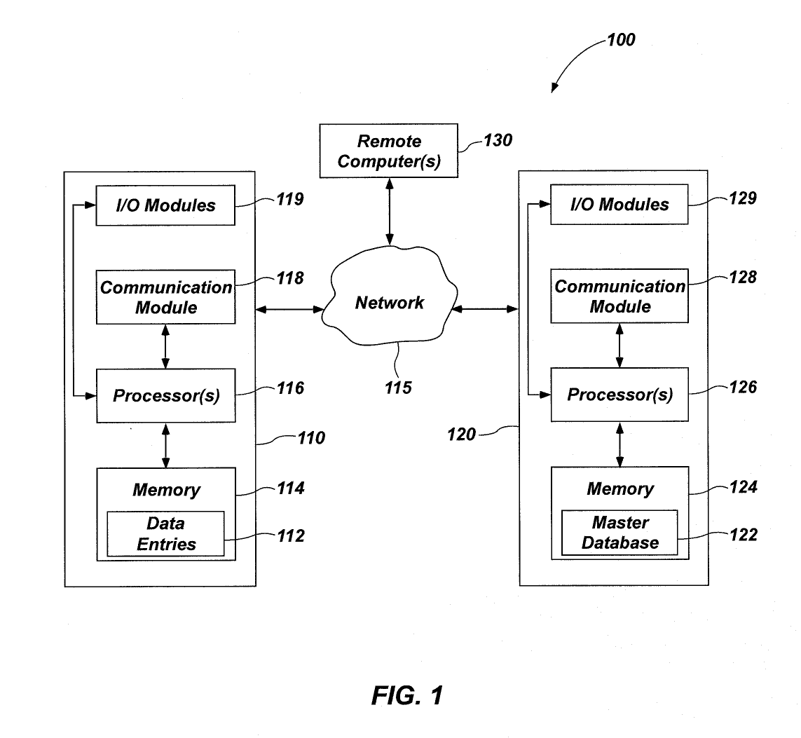

FIG. 1 is a schematic block diagram of a sales lead generation system 100 for generating, organizing, and managing sales leads for service contracts and other related information according to an embodiment of the present disclosure. The sales lead generation system 100 includes a mobile device 110 and another hardware device 120 that houses a master database 122 that are operatively coupled, such that the mobile device 110 and the master database 122 may communicate with each other and share information over a network 115.

The hardware device 120 may include memory 124, one or more processors 126, a communication module 128, and I/O modules 129. The one or more processors 126 may be configured to execute computing instructions for performing processes related to embodiments of the present disclosure. The memory 124 (which may include volatile and non-volatile memory) may be included to store the computing instructions for execution by the one or more processors 126 and data related to performing processes of one or more embodiments of the present disclosure. As a non-limiting example, the master database 122 may be stored in the memory 124. The communication module 128 may be included for performing the data communications through the various communication paths described herein. The input/output (I/O) modules 129 may be included for interfacing with a user, other communication devices, other computing devices, or a combination thereof. The hardware device 120 may be a server, a computer, etc. The master database 122 may store data related to existing customers, potential customers, sales leads, upcoming jobs, and other related information of the servicing company. The network 115 may include one or more wired or wireless communication paths between the mobile device 110 and the master database 122. For example, the network 115 may enable data communication through various communication paths, such as via satellite, cellular base stations, fiber optic transmission lines, wired transmission lines, etc.

The mobile device 110 may be a smart phone, a tablet, a laptop computer, or other electronic device configured to execute software thereon, and that may communicate with the master database 122 over the network 115. In particular, the mobile device 110 may be configured to send and receive data regarding existing customers and potential customers with respect to generating sales leads for service work, and regarding the actual service jobs performed. The mobile device 110 may include data entries 112 stored locally that synchronize at least some information with the master database 122, as will be discussed further below. The network 115 may be a dedicated network for the mobile device 110 and the master database 122, or a global network, such as the Internet. The sales lead generation system 100 may further include one or more remote computers 130 coupled with the network 115, which may have access to at least some of the information stored in the master database 122.

The mobile device 110 may include memory 114, one or more processors 116, a communication module 118, and I/O modules 119. The one or more processors 116 may be configured to execute computing instructions for performing processes related to embodiments of the present disclosure. The memory 114 (which may include volatile and non-volatile memory) may be included to store the computing instructions for execution by the one or more processors 116 and data related to performing processes of one or more embodiments of the present disclosure. As a non-limiting example, the data entries 112 may be stored in the memory 114. The communication module 118 may be included for performing the data communications through the various communication paths described above. The input/output (I/O) modules 119 may be included for interfacing with a user, other communication devices, other computing devices, or a combination thereof.

Although the service work is described herein in terms of the sign service industry (e.g., servicing billboards, electronic displays, business signs, etc.), embodiments of the present disclosure are contemplated to include other service industries, such as yard care, painting, building maintenance, snow removal, asphalt repair, home repair, and other contractor and service industries in which a service patroller may patrol an area for visual inspection to identify a service that may be desirable for a person or business who may be an existing customer or potential customer of a particular servicing company. Also, most of the discussion relates to outdoor patrolling; however, some services may be performed indoors, and patrolling may also be performed indoors where the service patroller may be permitted. For example, a sign may be located indoors at a location that is accessible to the public, and where the service patroller may be able to appropriately inspect the need for service work on the sign. In addition, while existing customers and potential customers are described herein as a business or a location that has some type of sign, depending on the type of service provided, the customers of the servicing company may be individuals as well as businesses or other organizations. Thus, services may be provided at residential properties, commercial properties, public properties, or other locations.

The sales lead generation system 100 may be used (e.g., operated, accessed, etc.) by a number of different people. For example, the service patrollers may be individuals employed by the servicing company to patrol an area and identify potential opportunities for service work. Thus, the service patrollers provide assistance for salespeople for the servicing company, by seeking opportunities to provide services to new customers, or seeking opportunities to provide additional services for existing customers. In some situations, an existing customer may have a contract for periodic services to be performed over a defined period of time, such as to perform regular maintenance of signs, and perform repairs as needed. In such a situation, the service patroller may have a regular route to monitor and to take care of the needs of these existing customers. As anomaly conditions are identified, the repairs are performed as part of the servicing contract. While completing a regular route, the service patroller may seek out additional opportunities for providing services. In that context, the service patroller may use the mobile device 110 configured according to the embodiments of the present disclosure to assist in sales lead generation, organization of customer information, and route assistance. The generic term “customer” is intended to refer to either an existing customer or a potential customer. In addition, a “sales lead” may refer to an indication for an opportunity to perform service work for a customer, even if that service work is already covered by a contract with the existing customer and does not generate new revenue.

In addition, while completing the route, the service patroller may use the mobile device 110 to take pictures of signs of existing customers to be stored in the master database 122 even if no anomaly condition was detected. For example, pictures of the functioning signs may be stored for a historical record of the sign. In addition, the pictures may be sent to the existing customer to show a proof of performance that the sign was patrolled according to their agreement and that everything was in order.

Another person that may use components of the sales lead generation system 100 may be service technicians of the servicing company. If the sales lead results in an actual service job to be performed, the service technicians perform the actual service desired. In that context, the service technicians may use the mobile device 110 configured according to the embodiments of the present disclosure to assist in reviewing the service request, preparing for performing the service, documenting the service performed, and other related information related to the execution of performing a service job. It should be understood that although it is described that both service patrollers and service technicians use the mobile device 110, each person may have their own separate mobile device 110 that is configured to perform their tasks. In addition, in some embodiments, each mobile device 110 may be configured essentially the same; however, each person's login privileges may determine which functions each person has access to.

Other people that may use components of the sales lead generation system 100 may be office personnel of the servicing company. For example, office personnel may desire to monitor the work and performance of the service patrollers, service technicians, or both. In addition, office personnel may desire to access information regarding existing customers, potential customers, sales leads, upcoming jobs, employees, and other information stored in the master database 122. For example, office personnel may include managers and their assistants, whose responsibilities may include managing and scheduling jobs, verifying accuracy of records, maintaining customer satisfaction, assigning roles of employees, and other managerial and clerical duties. In addition, office personnel may include salespeople whose responsibility may include following up on sales leads. In those contexts, the office personnel may have access to the master database 122, such as directly through the computer storing the master database 122. In some embodiments, the office personnel may access the master database 122 through the remote computers 130, such as by logging into an account over the Internet that provides them with such access to the information of the master database 122. Thus, the remote computers 130 may access the master database 122 using an Internet-based application that enables the user to view and manage the daily tasks of the servicing company. In some embodiments, the service patrollers and the service technicians may be given access privileges to access at least some of the information stored in the master database 122. Of course, it is to be understood that a service patroller, a service technician, and office personnel are described generally in terms of likely job duties; however, they need not be separate people. For example, a single person may perform one or more duties from the different types of employee types discussed herein.

The sales lead generation system 100 may permit one or more mobile devices 110 to access the master database 122. For example, a servicing company may employ any number of service patrollers and service technicians, with each having their own mobile device 110 that may be authorized to communicate with the master database 122. The mobile device 110 may further include various components, including a global positioning system (GPS), a microphone, a camera, etc. Thus, the mobile device 110 may further be configured to communicate and exchange data with a satellite, such as obtaining locational data, such as GPS data. In some embodiments, the mobile device 110 may have such components integrally formed within a single housing, while in other embodiments, one or more of such components may be separate devices that communicate such data with each other or separately to the master database 122.

The mobile device 110 and the master database 122 may be configured to synchronize at least some information with each other. Synchronization may occur substantially simultaneously at the time when changes are made to the data entries 112 of the mobile device 110 by the service patroller. In some embodiments, synchronization may occur periodically according to some synchronization schedule. Changes may be stored locally and transmitted as a group (batch) during synchronization. In some embodiments, synchronization may additionally be initiated manually outside of the synchronization schedule, if desired. If service is unavailable for the mobile device 110 and the master database 122 to connect for synchronization, the sales lead generation system 100 may wait to synchronize when the connection between the mobile device 110 and the master database 122 is again detected.

In some embodiments, a local version of the master database 122 (i.e., a local database) may be stored in memory 114 of the mobile device 110. Such a local database may include substantially all information from the master database 122, or in some embodiments, only a portion thereof. For example, some information stored in the master database 122 may not be necessary for service patrollers to make and edit data entries 112, such that this information may not be needed for local storage. In this embodiment having a local database, data entries 112 that are added or edited by the service patroller may first be saved in the local database, and then such changes may be synchronized with the master database 122 to apply the appropriate changes to the master database 122. In embodiments having a local database rather than simple data entries, changes to the master database 122 may initiate synchronization from the master database 122 side to update the local database. Such synchronization may be done in real-time, periodically as a batch, manually, or a combination thereof.

In operation, the service patrollers may patrol an area looking for opportunities for service work, such as detecting anomalies of the signs for both existing customers and potential customers. As they patrol the area, the service patroller may use the mobile device 110 to identify a particular route to travel for patrolling the area. For example, the mobile device 110 may display a map showing the service patroller's location. The map may be populated with indicators showing locations of existing customers in the area to check up on. While the service patroller is travelling along this route, the service patroller may identify potential customers that may have a need for such services. The service patroller may use a data entry feature of the mobile device 110 to generate a sales lead that is transmitted to the master database 122. Likewise, if an existing customer has a need for a service, the service patroller may use the data entry feature of the mobile device 110 to generate a sales lead that is transmitted to the master database 122. The sales lead may be stored in the master database 122, which may later be accessed in order to follow up on the sales lead. For example, following up on the sales lead may be done in person, via phone, email, letter, etc., to make the potential customer aware of the anomaly condition, and to offer a bid to repair the sign as a single job, or by establishing an ongoing service contract.

In one embodiment, a sales lead form may automatically be created. The sales lead form may show the customer information, picture, and description provided by the service patroller. The sales lead form may be accessed by office personnel, such as by a salesperson to follow up with the customer to discuss the anomaly condition and the recommended service to remedy the anomaly condition. The information from the sales lead form may also be used to create a proposal to be sent to the customer to inform the customer of the anomaly condition, with a request to perform the recommended service. Such a proposal may also include a bid or an estimate of the costs to perform the recommended service. The proposal to be automatically generated and sent (e.g., via mail, email, text, fax, etc.) to the existing customer as the customer information will already have been verified previously.

Additional information may also be sent to the master database 122 by the mobile device 110. For example, the mobile device 110 may track its movement to verify that the service patroller completed the proper route, and transmit such information to the master database 122. In addition, information regarding the service jobs performed by the service technician may be sent to the master database 122. For example, the service technician may use a data entry feature of the mobile device 110 to report the completion of the service job, including details of the job including time worked, employees present, parts used, etc. For both sales lead generation and job verification, media files (e.g., image files, video files, and audio files) may be transmitted to the master database 122.

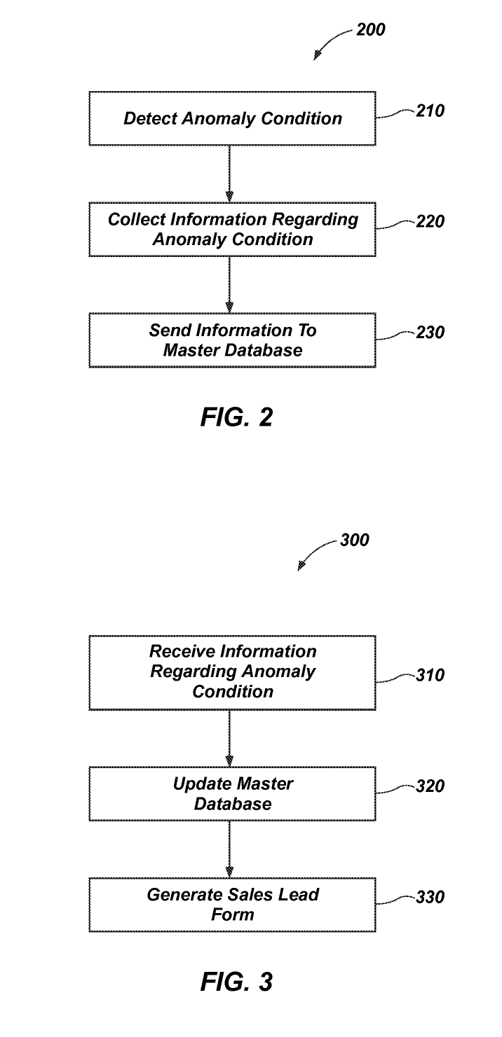

FIG. 2 is a flowchart 200 illustrating a method for generating a sales lead for a company in a service industry according to an embodiment of the present disclosure. For example, the method may be performed by a service patroller using the mobile device 110 (FIG. 1). At operation 210, the service patroller may detect an anomaly condition that may be remedied by performing some service. For example, the anomaly condition may be an outage for an electronic display for an outdoor sign. The service patroller may detect the anomaly during the service patroller's route while seeking opportunities for service work for customers, such as while monitoring the signs for existing customers of the company. The anomaly condition may exist at one of the locations of an existing customer, or at a location of a potential customer.

At operation 220, information regarding the anomaly condition and the customer may be collected. For example, the service patroller may enter data (e.g., company name, street address, a brief description of the anomaly, etc.) into the mobile device 110. The service patroller may also create one or more media files to attach with the data. The media files may include an image file, a video file, and an audio file. For example, the image file may show the anomaly condition. The information may include GPS data having latitudinal data and longitudinal data for the location of the anomaly condition. The GPS data may be embedded within the media file. Some of the customer information may be entered manually by the service patroller, while some information may be retrieved from querying either the local database (if present) of the mobile device 110 or the master database 122 for existing customers. Some information for potential customers may be retrieved by querying external sources, such as online directories, phone books, search engines, and company websites. In some embodiments, querying may be performed by the mobile device 110. In some embodiments, querying may be performed on the backend computer storing the master database 122. At operation 230, the information edited and/or entered in the data entries 112 may be sent from the mobile device 110 to the master database 122 as sales lead information for storage and further processing.

FIG. 3 is a flowchart 300 illustrating a method for generating a sales lead for a company in a service industry according to an embodiment of the present disclosure. For example, the method may be performed on the backend device storing the master database 122 (FIG. 1). At operation 310, sales lead information may be received from the mobile device 110 (FIG. 1). The sales lead information about an anomaly condition for a customer. For example, the sales lead information may include identifying information for the customer and at least one media file indicating an anomaly condition at a location of the customer. The sales lead information may further include a description of the anomaly condition. The anomaly condition may, for example, include one of an electrical anomaly condition and a physical anomaly condition of an electronic display. The at least one media file may include an image file showing the anomaly condition.

At operation 320, the master database 122 may be updated. The sales lead information may be compared to existing customers on record in the master database 122 to match the sales lead with the existing customer, if present. Verifying an existing customer may be performed by comparing information from the sales lead information and information stored in the master database 122, such as GPS data. If the customer is not verified as an existing customer, a new entry may be created for a sales lead for a potential customer not already in the master database 122. In some embodiments, this matching may be performed on the mobile device 110 side. In some embodiments, such matching may be performed on the server side, either automatically or manually.

The sales lead information received from the mobile device 110 may also be supplemented with additional information regarding the customer when editing/adding data entries 112. For example, a customer contact person associated with that customer may be included in the sales lead record stored in the master database 122. For existing customers, this supplemental information may be present readily available and in the master database 122. For potential customers, this supplemental information may be retrieved through external sources, and may require some manual entering if automatic external searches are unsuccessful.

At operation 330, a sales lead form may be generated. For example, the sales lead form may display the sales lead information, including the display of an image showing the anomaly condition and the identifying information for the customer. Such a sales lead form may be automatically generated responsive to reception of the sales lead information from the mobile device 110. The sales lead form may also include some of the supplemental information on the sales lead record, such as customer contact information. The sales lead form may be accessed by office personnel, such as by a salesperson to follow up with the customer to discuss the anomaly condition and the recommended service to remedy the anomaly condition. The information from the sales lead form may also be used to create a proposal to be sent (e.g., via mail, email, text, fax, etc.) to the customer to inform the customer of the anomaly condition, with a request to perform the recommended service. Such a proposal may also include a bid or an estimate of the costs to perform the recommended service.

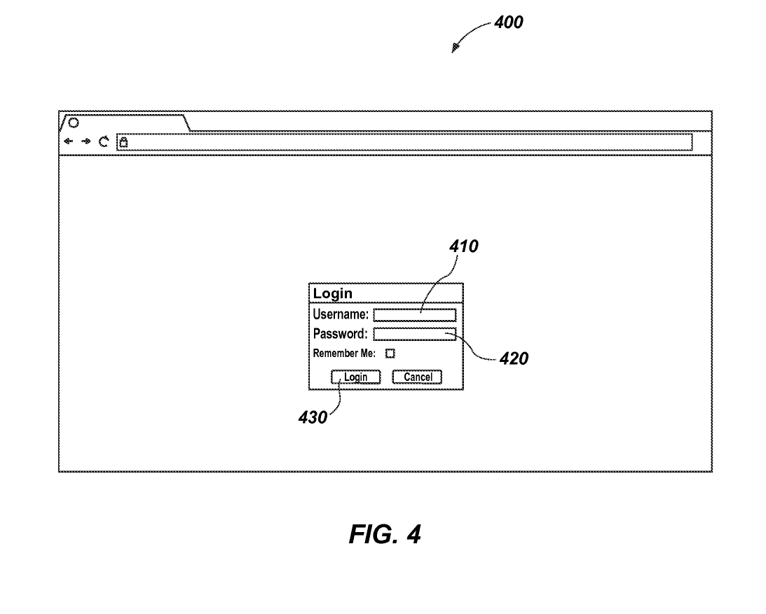

FIGS. 4 through 14 show a variety of GUIs 400 through 1400 that may be employed for accessing and organizing information stored in the master database 122 of FIG. 1 according to an embodiment of the present disclosure. For example, the GUIs 400 through 1400 may be displayed by a web browser from a remote computer 130 (FIG. 1). Thus, the GUIs 400 through 1400 may be displayed on the remote computer 130 by an Internet-based platform that enables a user (e.g., office personnel) to manage the daily tasks (e.g., keep track of customers, jobs, sales leads, employees, etc.) needed to manage the servicing company's business as discussed above. For these examples, the user is described as being the office personnel; however, it is contemplated that other users (e.g., service patrollers, service technicians) may have access privileges to at least some of this information.

In FIG. 4, the GUI 400 may be presented to the office personnel as a login screen for the platform. The GUI 400 may include login fields 410, 420 for the office personnel to be authenticated and gain access to the platform. After the office personnel types in a valid username and password in the login fields 410, 420, the office personnel may gain access to the platform by pressing a login button 430. Each unique login identity may have different access privileges.

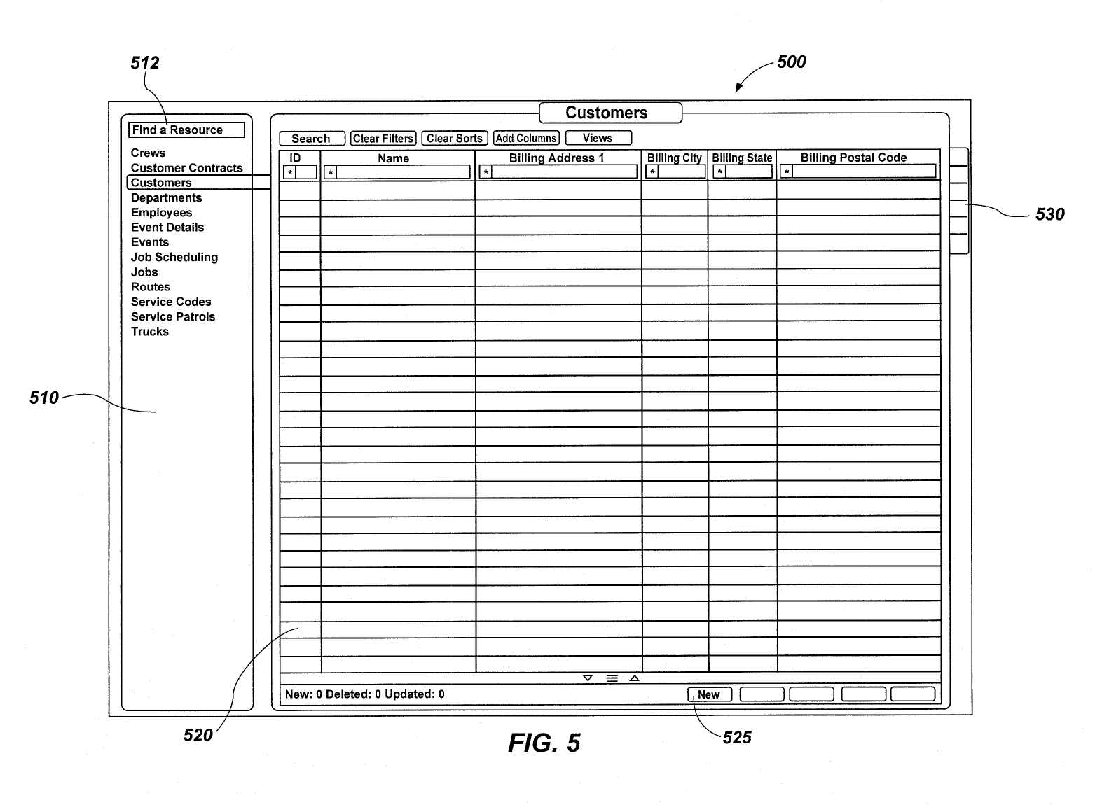

In FIG. 5, the GUI 500 may be presented to the office personnel as the main interface that is accessible after logging in to the platform. The main interface may include a resource bank area 510, a grid area 520, and a resource actions panel 530.

The resource bank area 510 displays a list of available resources to the office personnel for the main interface. The resources listed in the resource bank area 510 may be different from user to user depending on access privileges. In addition, the list of resources may include others not specifically shown in FIG. 5. For a particularly large number of resources listed in the resource bank area 510, a resource search field 512 may be used to search for resources.

The grid area 520 may include a plurality of fields for displaying information from the master database 122. The information displayed in the grid area 520 may vary depending on the resource selected. For example, as shown in FIG. 5, the customers' resource is selected. As a result, the information listed in the grid area 520 will relate to the existing customers of the servicing company. Each of the rows display information that belongs to the same record, which in this example is a particular customer. Each of the columns of the grid area 520 displays a common field among different records. For example, each customer may include information fields, such as a customer ID, a customer name, a billing address, a billing city, a billing state, and a billing postal code. The grid area 520 may be customizable and searchable. For example, the grid area 520 may be configured to enable the office personnel to add columns, remove columns, size columns, and filter information in columns, sort columns, and view the record count for the total number of records shown in the grid area 520. Each of these functions may be performed in a variety of ways. For example, adding a column may be performed by dragging and dropping a column onto the grid area 520 from among a list of available columns. Additional columns may include billing term, country, job dates, among others. Removing a column may be performed by selecting on an “X” button at the top corner of the column to be removed. Sizing a column may be performed by dragging the edge of the column to the left or right to make the column wider or narrower. Filtering information in the columns may be performed by typing in search terms into the data entry field located at the top of the column. Sorting columns may be performed by selecting the name of the column in the column header, which may result in the information displayed in the column to be sorted alphabetically or numerically.

Searching for records in the grid area 520 may be performed for a variety of different fields of the customer information. For example, typing a city into the city column will display all customers located in that city. Searching may be performed by combining multiple fields, such as generating a list of all the jobs done for a certain customer within a certain timeframe. By entering search criteria into the customer column, and then entering the appropriate dates in the date started and date completed columns (not shown), such records may be displayed. Wild characters and root expanders may also be used in the search terms to further broaden the search. In addition, more than one search term at a time may be entered within the same column.

The resource actions panel 530 may be configured to enable the office personnel to perform a variety of tasks related to the grid area 520. For example, the resource actions panel 530 may include functionality for attaching documents to the records of the grid area 520, export the records of the grid to a CSV file, print the records of the grid area 520, refresh the grid area 520, save the layout of the grid area 520, and other similar functions.

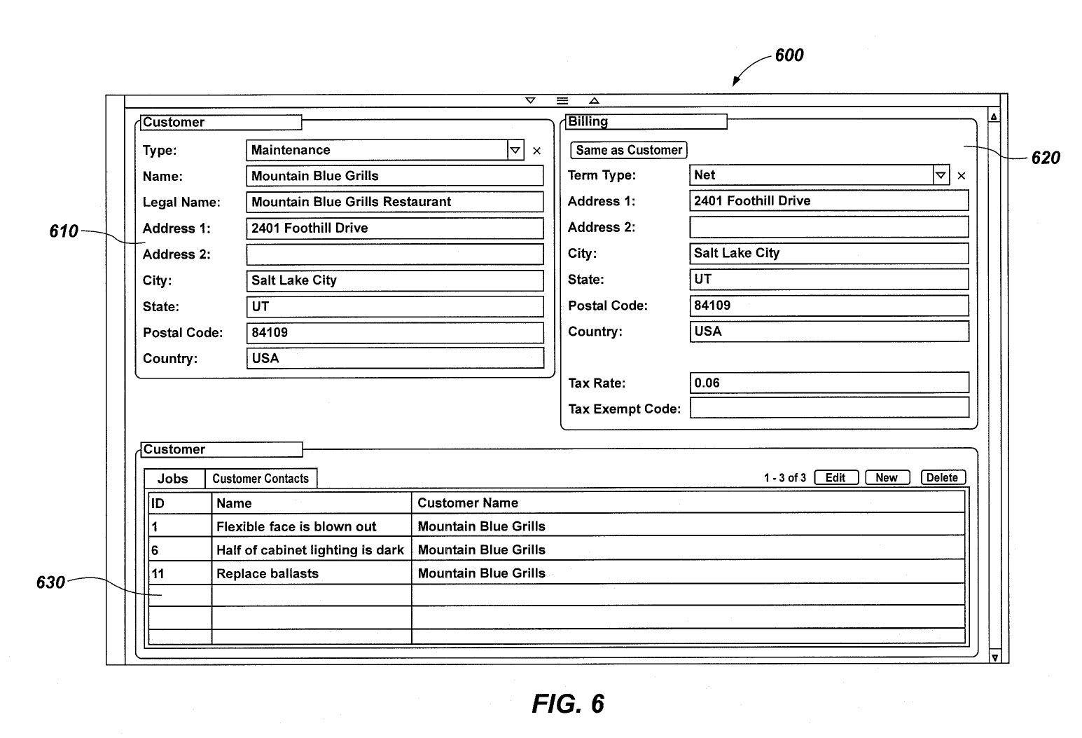

In FIG. 6, the GUI 600 may be presented to the office personnel as the customer form interface that is accessible responsive to selecting an individual record shown in FIG. 5. For example, a customer record for “Mountain Blue Grills” may be selected. The customer and billing information may be editable, such that the office personnel may manage and edit the information as needed to remain current. The customer form interface may display more detailed information of the records of the grid area 520 (FIG. 5). For example, the customer form interface may include a customer area 610 that displays customer information, a billing area 620 that displays billing information for the particular customer, and a related resources area 630 that displays information from other resources related to this record. For example, the jobs resource and the customer contacts resource are shown as being related to the customers' resource in FIG. 5. As a result, information related to these resources may be accessed by this screen without having to leave the screen, such as by selecting the different resource in the resource bank area 510 (FIG. 5). Other screens corresponding to the other resources of the resource bank area 510 may also have a related resources area for resources related to the selected resource.

Referring again briefly to FIG. 5, the GUI 500 may also be used to enter information for a new customer by selecting the new customer button 525. Selecting the new customer button 525 may open a GUI similar to the GUI 600 of FIG. 6, but without any information listed therein. Thus, the office personnel may enter the information for the new customer and save the new customer record for the information for the new customer to be stored in the master database 122.

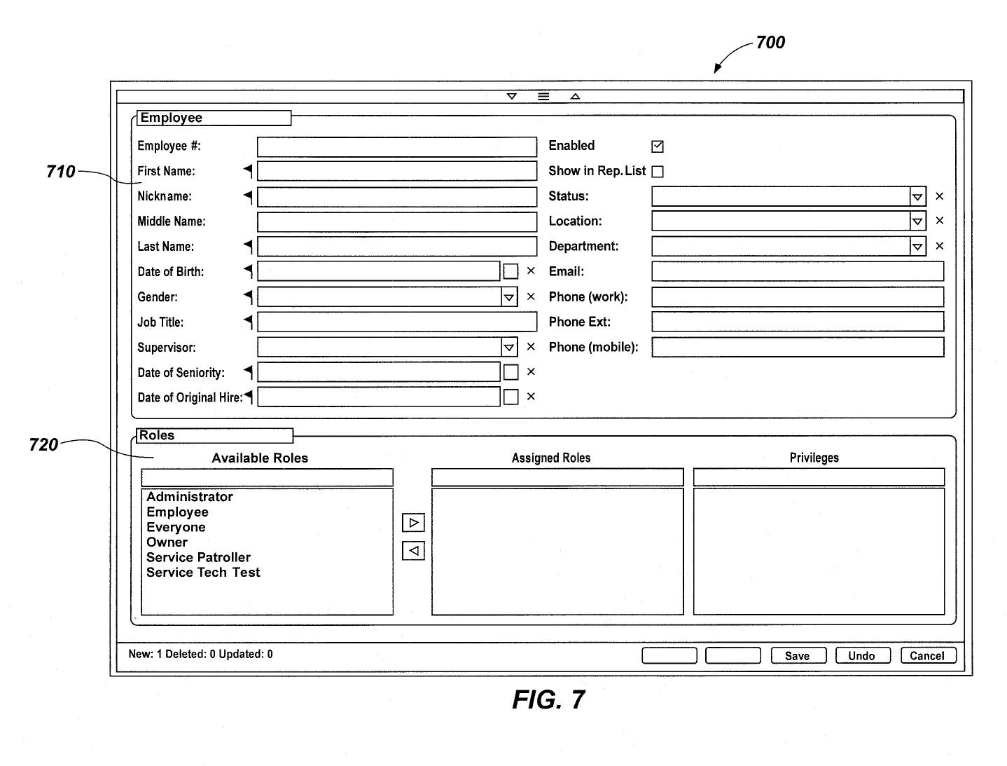

In FIG. 7, the GUI 700 may be presented to the office personnel as an employee form interface when selecting an individual record while the employee resource is selected in the resource bank area 510 (FIG. 5). In particular, the employee form interface may include an employee information area 710 (e.g., for displaying an employee number, first name, last name, date of birth, etc.). The employee form interface may further include a roles area 720 for the particular employee. For example, possible roles may include an administrator, an employee, an owner, a service patroller, and a service technician. For adding a new employee to the master database 122, the employee form interface may initially be blank when displayed, and may be filled out by the office personnel.

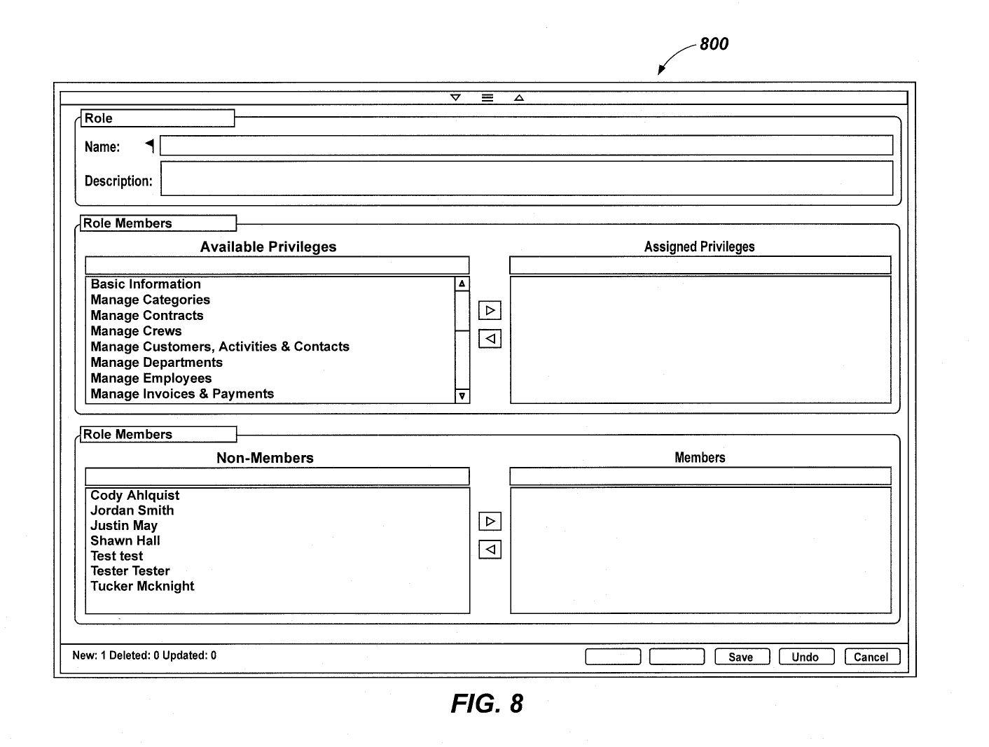

In FIG. 8, the GUI 800 may be presented to the office personnel as a roles form interface when selecting an individual record while the roles resource is selected in the resource bank area 510 (FIG. 5). With the roles interface, the employee may have a role assigned, which may further define the account privileges for the platform. For example, an employee may be assigned one or many roles, and may have certain privileges, such as adding and deleting invoices, modifying customer information, etc.

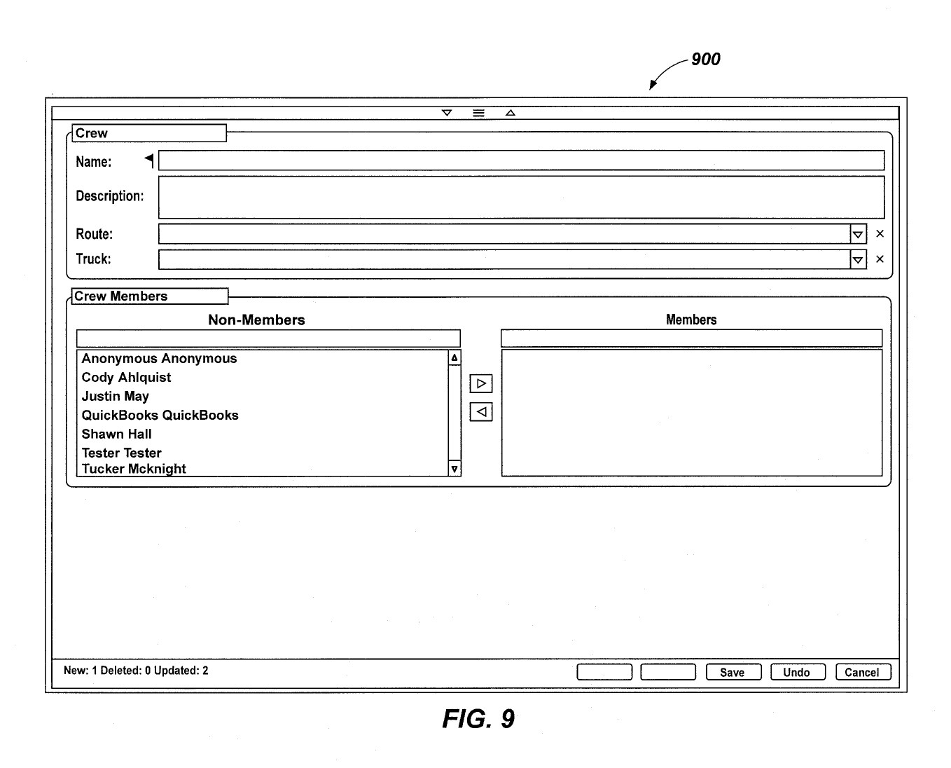

In FIG. 9, the GUI 900 may be presented to the office personnel as a crews form interface when selecting an individual record while the crews resource is selected in the resource bank area 510 (FIG. 5). A crew groups together employees into groups for jobs, service patrols, etc. Another similar resource is a trucks resource, which enables the office personnel to enter information related to the trucks of a fleet. Trucks may also be assigned to a particular crew in the crews form interface.

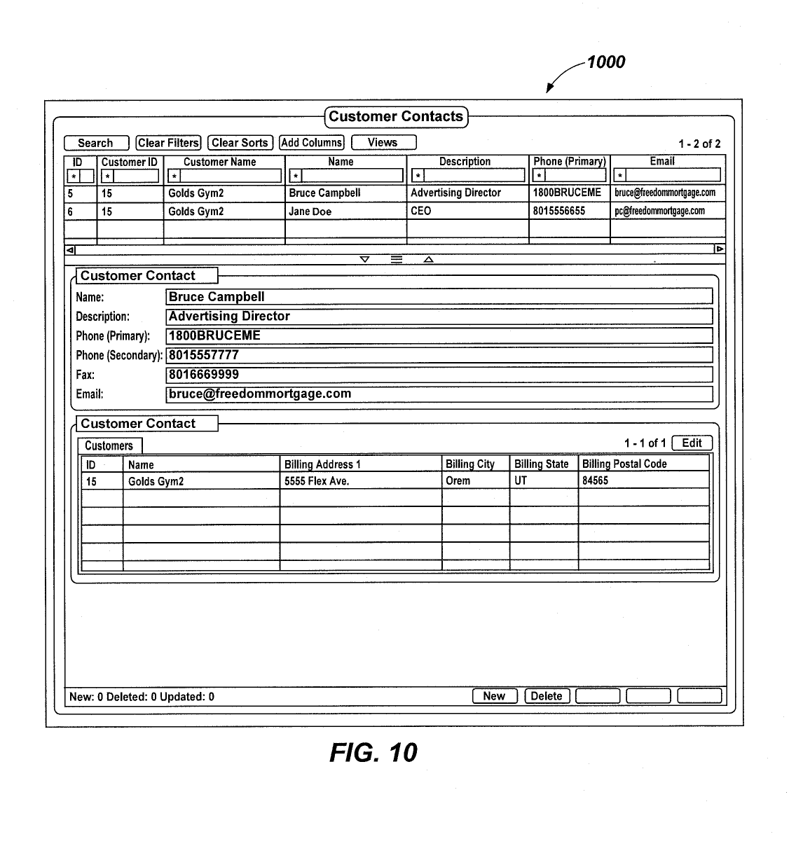

In FIG. 10, the GUI 1000 may be presented to the office personnel as a customer contacts form interface when selecting an individual record while the customer contacts resource is selected in the resource bank area 510 (FIG. 5). The customer contacts form interface displays customer contacts and related information, such as contact name, title, phone numbers, fax number, email addresses, and other information relating to the customers.

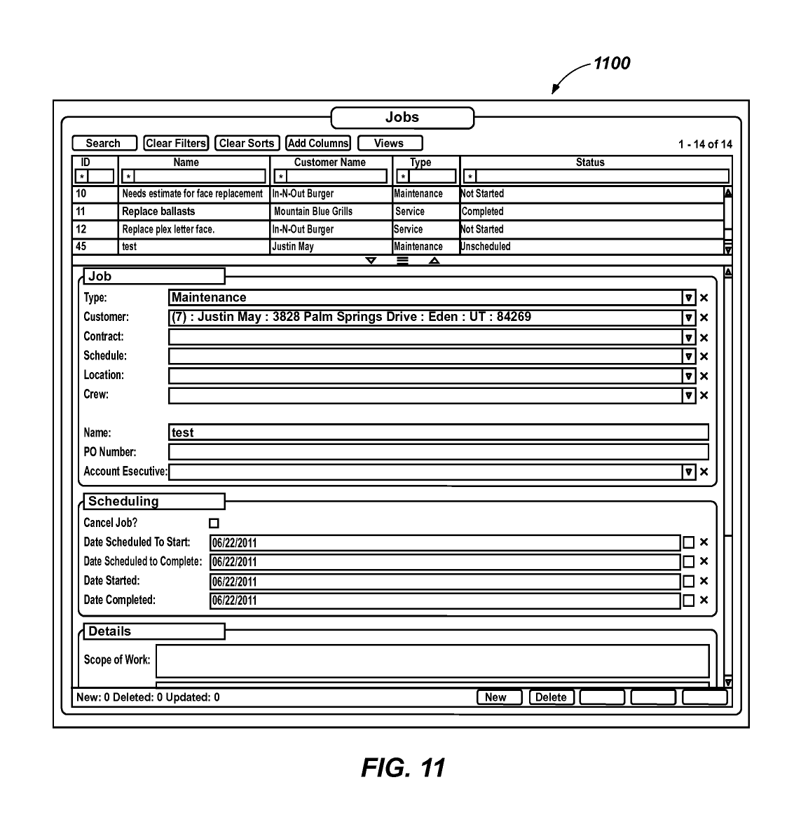

In FIG. 11, the GUI 1100 may be presented to the office personnel as a jobs form interface when selecting an individual record while the jobs resource is selected in the resource bank area 510 (FIG. 5). The jobs form interface displays job information, scheduling information, and other details related to a particular job. The jobs resource may keep track of all jobs entered into the system and stored in the master database 122, including past jobs, present jobs, and future jobs.

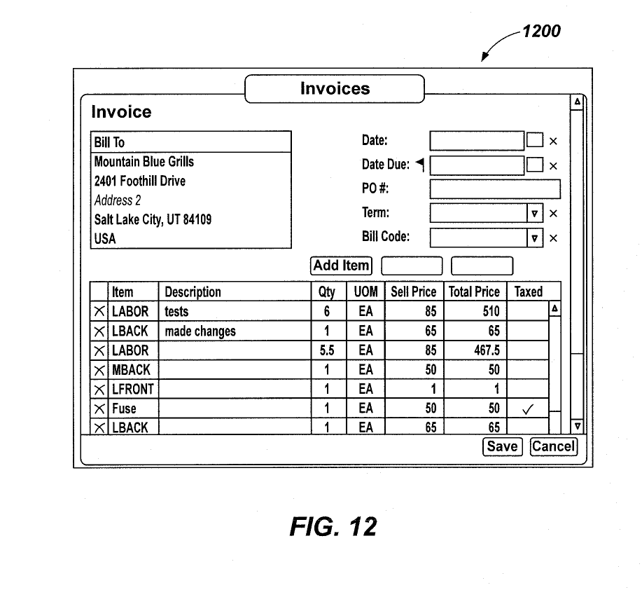

In FIG. 12, the GUI 1200 may be presented to the office personnel as an invoice form interface when selecting an individual record while the invoice resource is selected in the resource bank area 510 (FIG. 5). An invoice may also be created from the related resource field of the jobs form interface, which may automatically attach the invoice to a particular job. The line items shown on the invoice form interface may be imported from the job line items and converted to invoice line items. If there are multiple job line items that are the same, the multiple job line items may be condensed into one invoice line item with the quantity adjusted accordingly.

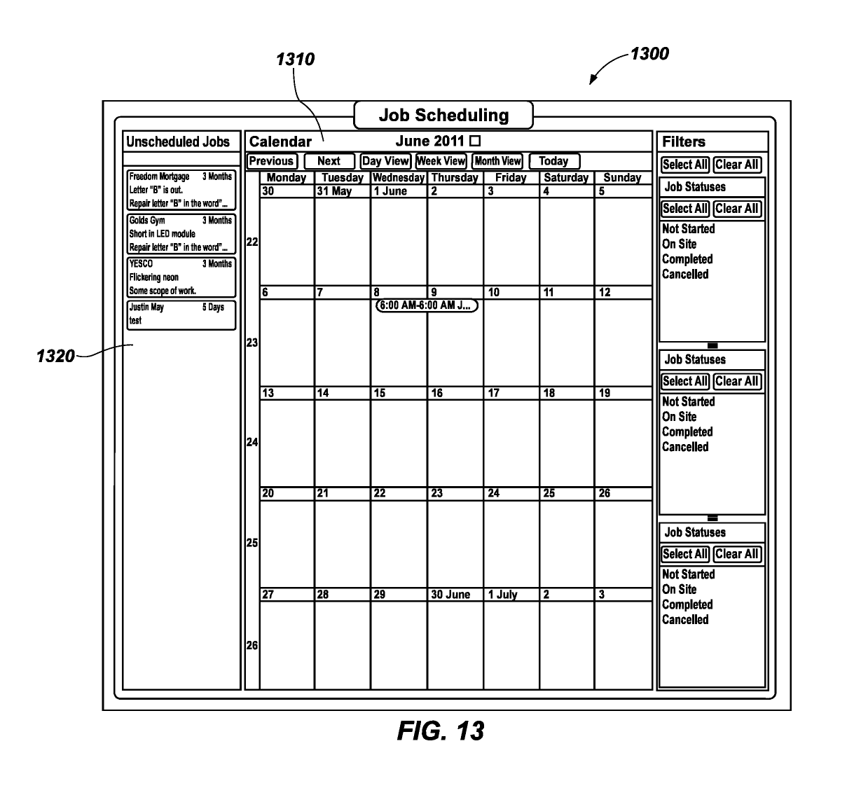

In FIG. 13, the GUI 1300 may be presented to the office personnel as a jobs scheduling form interface while the jobs scheduling resource is selected in the resource bank area 510 (FIG. 5). The jobs scheduling form interface may display a calendar 1310 as an editable field. The calendar may be viewed to show a day, a week or a month at a time. The jobs scheduling form interface may further include an unscheduled jobs list 1320, which may be listed in order of the date created with the oldest job showing first. To schedule a job, the job entry from the unscheduled jobs list 1320 may be dragged and dropped onto the calendar on the desired day. Once the job is on the calendar 1310, the details of the job may be edited. A job may be extended to cover more than one day.

Crews may be assigned when the job is set up or at the job scheduling phase. To assign or reassign a crew from the jobs form interface, the job may be selected from the calendar 1310 and the crew may be changed. The crews may also be filtered to see which jobs are assigned to which crews. With a crew filter activated, the platform may automatically assign an unscheduled job to the same crew being filtered when a crew-less job is dragged to the calendar 1310.

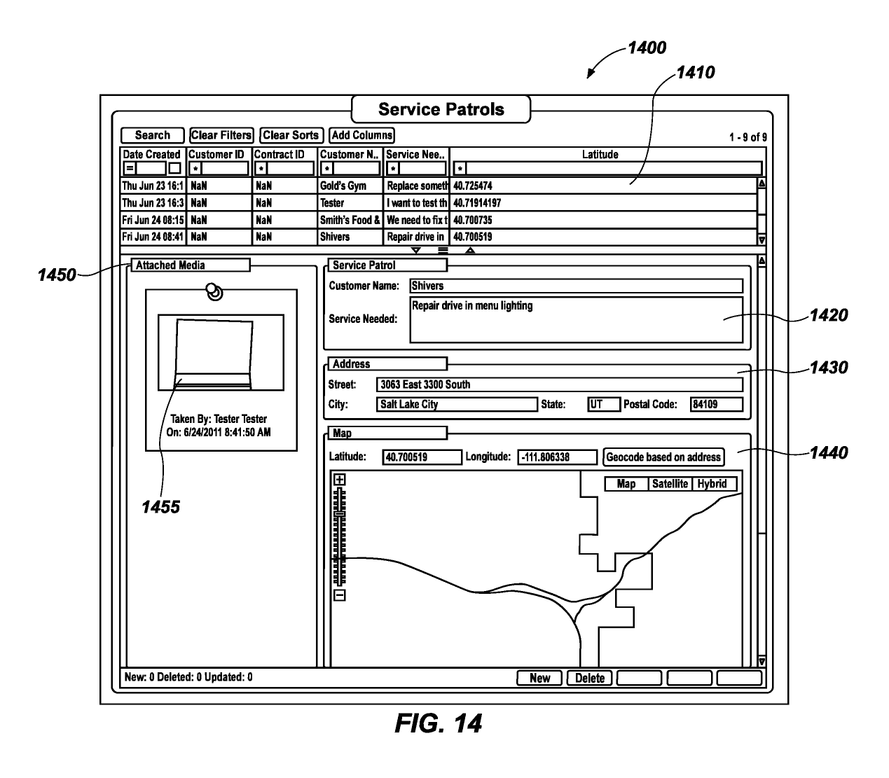

In FIG. 14, the GUI 1400 may be presented to the office personnel as a service patrols form interface while the service patrols resource is selected in the resource bank area 510 (FIG. 5). The service patrols form interface may display the sales lead information collected by the service patroller. Thus, the service patrols form interface may be referred to as the sales lead form. The service patrols form interface displays the anomalies (e.g., outages) identified with the associated sales leads generated by the service patrollers. The outstanding sales leads may be displayed in a grid area 1410, with information for a selected sales lead displayed in a sales lead description area 1420, an address area 1430, a map area 1440, and a media area 1450. The media area 1450 may attach the media files provided by the service patroller, such as a thumbnail image 1455. Thus, the GUI 1400 displays sales lead information, including the display of an image showing the anomaly condition and the identifying information for the customer. Such a sales lead foiin may be automatically generated responsive to reception of the sales lead information from the mobile device 110. The sales lead form and proposal may further be used for a salesperson to follow up with the customer to discuss the anomaly condition and the recommended service to remedy the anomaly condition. A proposal containing similar information (e.g., image, customer information, description of anomaly, etc.) as these sales lead forms may be created for the customer, as discussed above.

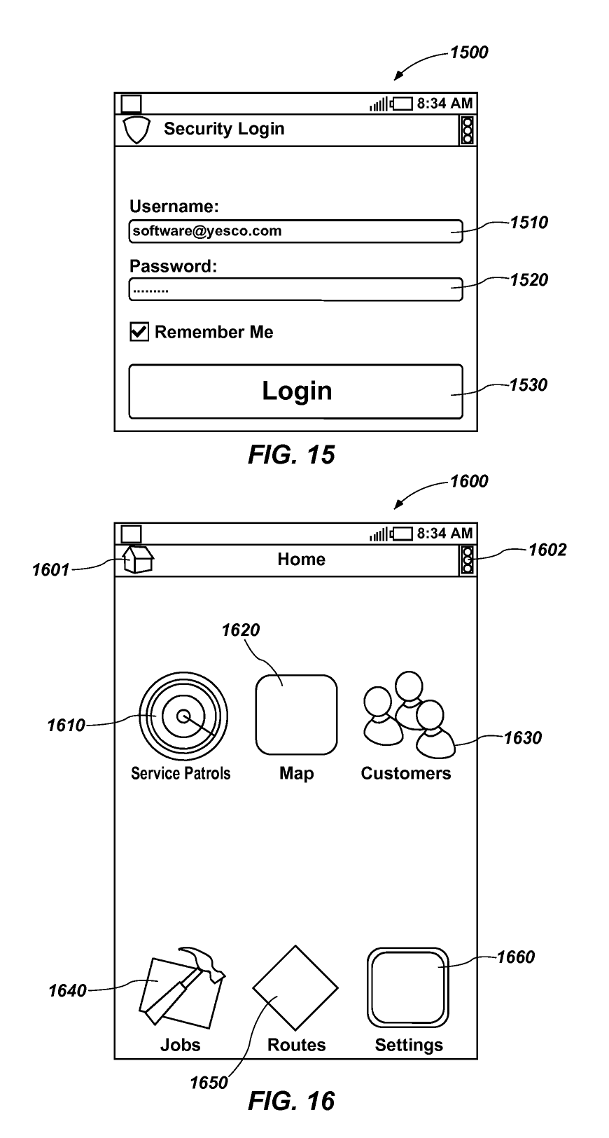

FIGS. 15 through 20 show a variety of GUIs 1500 through 2000 that may be employed for operating the mobile device 110 of FIG. 1 according to an embodiment of the present disclosure. In particular, the GUIs 1500 through 2000 may be accessible to service patrollers.

The GUIs 1500 through 2000 may be associated with an application, website, or other program or interface that may operate with the described functionality of capturing and submitting service patrol information and other sales lead generation information. For the examples given herein, the GUIs may be associated with an application installed on the mobile device 110 (FIG. 1) (e.g., smart phone, tablet, etc.) for the service patroller to generate sales leads or otherwise send data to the master database 122; however, it should be understood that the service patroller may use an Internet-based application that the mobile device 110 accesses through a web browser to communicate with the master database 122. One advantage of having an application installed directly on the mobile device 110 is that Internet connectivity may not be required at all times, and that the mobile device 110 may operate locally and data may periodically synchronize between the local database (if present) of the mobile device 110 and the master database 122, rather than being dependent on a persistent connection with the master database 122. In some embodiments, the mobile device 110 may use data entries 112 that are temporarily stored locally during editing/adding by the service patroller, and then deleted upon successful synchronization (submission) to the master database 122.

In FIG. 15, the GUI 1500 may be presented to the service patroller as a login screen responsive to selecting an icon on the display of the mobile device 110. The GUI 1500 may include login fields 1510, 1520 for the service patroller to be authenticated and gain access to the application. After the service patroller types in a valid username and password in the login fields, the service patroller may gain access to the application by pressing a login button 1530.

In FIG. 16, the GUI 1600 may be presented to the service patroller as the home application screen that is accessible after logging in to the application. The home application screen may include a plurality of icons for performing a variety of different functions. For example, the home application screen may display a service patrols icon 1610, a map icon 1620, a customers icon 1630, a jobs icon 1640, a routes icon 1650, and a settings icon 1660. The functionality associated with each of the service patrols icon 1610 and the jobs icon 1640 will be described further below. Selecting the map icon 1620 may display a map indicating the present location of the service patroller. In addition, the map may be populated with indicators showing nearby existing customers by using the address and/or GPS information associated with the customer records. Selecting the customers' icon 1630 may display a list of the customers, which may include additional related customer information. The displayed customer list may be the entire customer list from the master database 122, but in some embodiments, the displayed customer list may be limited to a particular geographic region from where the service patroller currently is. Selecting the routes icon 1650 may display one or more routes assigned to the service patroller. The displayed route may be depicted as a map showing the route and the customers for monitoring on that route. In some embodiments, the route may be depicted as merely a list of customers on the route, their locations, and the order for visiting each customer on the list. The settings icon 1660 may enable the service patroller to change personal settings of the application or the mobile device, such as username, password, display options, etc.

The GUI 1600 may also include navigation buttons 1601 that enable the service patroller to navigate between GUIs. The GUI 1600 may also include a synchronization indicator 1602. As discussed above, the mobile device 110 may synchronize with the master database 122. The synchronization indicator 1602 may indicate the availability for connection with the master database 122 and the status of the synchronization. For example, the status indicator 1602 may be represented as a traffic light icon. A red light may indicate that a data connection is not available, and that the mobile device 110 will not be able to synchronize with the master database 122. A yellow light may indicate that a data connection is available, but that the service patroller is not yet logged into the application. A green light may indicate that a data connection is available, and that the service patroller is logged into the application. When the light is green, synchronization may occur between the mobile device 110 and the master database 122.

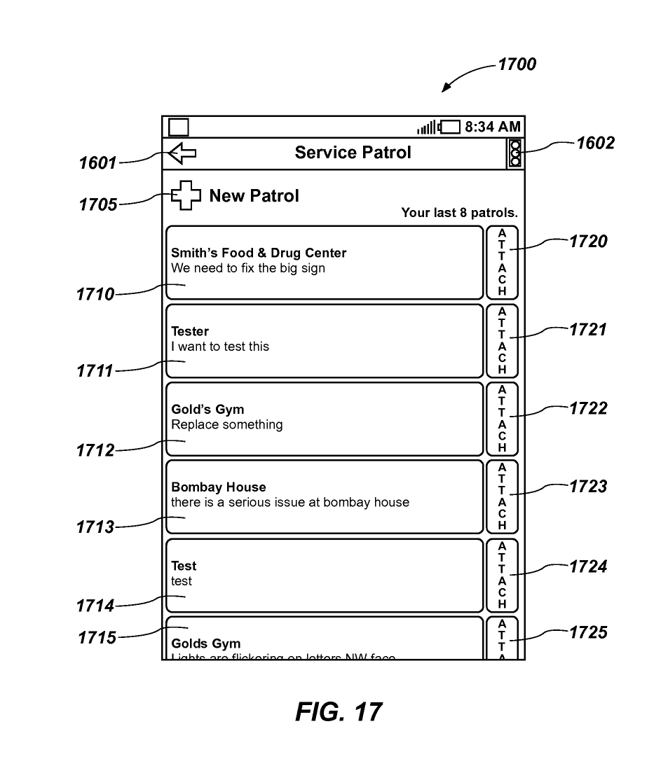

In FIG. 17, the GUI 1700 may be presented to the service patroller as the service patrol home screen of the application responsive to the service patroller selecting the service patrols icon 1610 of FIG. 16. The service patrol functionality of the application enables the service patroller to record and keep track of potential service opportunities due to identified anomalies by the service patroller, such as sign outages, damage, routine maintenance, and other related anomalies. As discussed above, patrolling refers to the service patroller monitoring (e.g., inspecting) an area looking for potential opportunities to provide service work to a customer. Patrolling may include monitoring the status of existing customers according to a route, but also in monitoring the status of potential customers along the route.

The service patrol home screen shows service patrol entries 1710, 1711, 1712, 1713, 1714, 1715 that the service patroller has created during a service patrol. Each service patrol entry 1710, 1711, 1712, 1713, 1714, and 1715 may include a description of the location of the potential service sales lead, as well as a brief description of the work that may be desired. For example, the first service patrol entry 1710 indicates that “Smith's Food and Drug Center” may have some need for service work to be performed, and that “the big sign” may need to be fixed. Each of the service patrol entries 1710, 1711, 1712, 1713, 1714, 1715 may have a corresponding attachment button 1720, 1721, 1722, 1723, 1724, and 1725 for attaching a media file to accompany the description in the service patrol entry. Media files may include one or more of an image file, an audio file, and a video file. A new entry may be created by the service patroller by selecting a new service patrol button 1705.

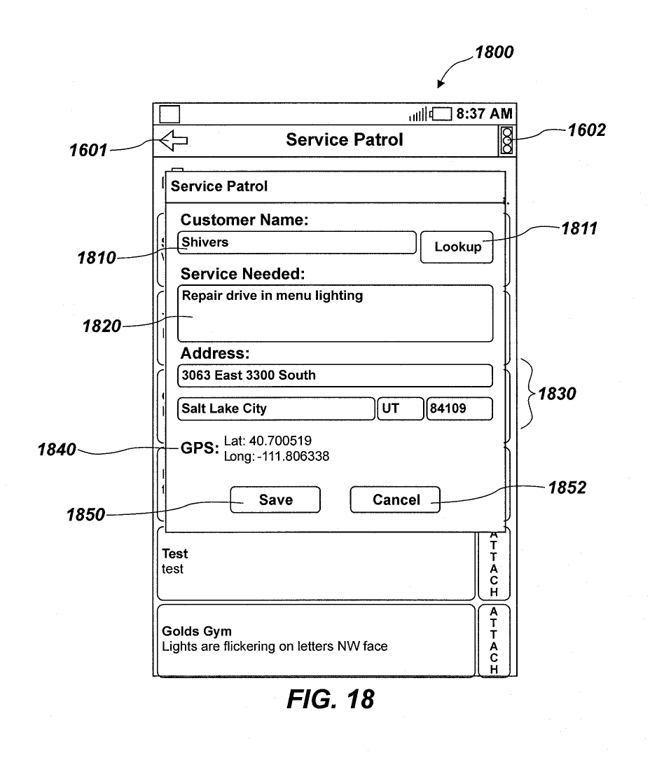

In FIG. 18, the GUI 1800 may be presented to the service patroller as the new service patrol entry screen of the application responsive to the service patroller selecting the new service patrol button 1705 of FIG. 17. The new service patrol entry screen may include a customer name field 1810, a service needed field 1820, an address field 1830, and a GPS field 1840. The customer name field 1810 may indicate the name of the sales lead that may have a need for service work to be performed. In the example shown in FIG. 18, the sales lead is “Shivers.” The service needed field 1820 may indicate the nature of the work that may need to be performed at that location. The address field 1830 may indicate the address of the sales lead, including the street address, city, state, and zip code. The GPS field 1840 may indicate the GPS coordinates (e.g., latitude and longitude) for the sales lead, which may be populated by obtaining the present GPS information from the GPS of the mobile device 110 (FIG. 1).

The new service patrol entry screen may further include a lookup button 1811 that enables the service patroller to search the name of the potential sales lead. For example, the service patroller may enter the name (or partial name) of the business and press the lookup button 1811. The mobile device 110 may search its local database (if present) for customers having that name. In some embodiments, the mobile device 110 may query the master database 122. The mobile device 110 may distinguish between similar customers based on the current GPS location of the mobile device 110 and known GPS locations of existing customers. If the customer information is found, the official name of the business may be shown in the customer name field 1810, and the address field 1820 may be populated with the stored data for that customer. In some embodiments, the mobile device 110 may also search other external databases (e.g., web services such as search engines, online directories, etc.) to obtain the appropriate information for potential customers that are not listed as an existing customer. Using the lookup feature may save the service patroller time from having to enter in the full name and address of every new service patrol, and doing so may also improve the accuracy of information that is submitted into the system. In addition, using external searches to obtain information regarding a potential customer may result obtaining in customer contacts that are better positioned to make a decision regarding the offered service.

If, for some reason, the mobile device 110 is not able to find the name of the business that has been entered, the service patroller may manually type the name and address of the business into the appropriate fields 1810, 1830. Of course, the name and address information may be manually entered without first using the lookup feature. The service patroller may also enter a description of the recommended service in the service needed field 1820. This description may be entered by manually typing into the service needed field 1820. In some embodiments, one or more of the fields may be filled out using dictation software and the microphone of the mobile device 110.

The service patroller may save the new service patrol entry by pressing the save button 1850 or cancel the new service patrol entry by pressing the cancel button 1852. Pressing the save button 1850 may save the information locally on in the data entries 112 (and/or a local database) of the mobile device 110, and which may further be synchronized to update the master database 122. As previously discussed, synchronization with the master database 122 may occur simultaneously when changes are made, or periodically according to some synchronization schedule. If service is unavailable for the mobile device 110 to connect to the master database 122 for synchronization, the mobile device 110 may wait to synchronize when the connection to the master database 122 is again detected. After the new service patrol has been entered as a sales lead, any inaccuracies in the entered information may be edited in the master database 122, if necessary. In addition, office personnel may do a further investigation concerning the potential customer, customer contact, etc., to further tailor the sales lead to the customer.

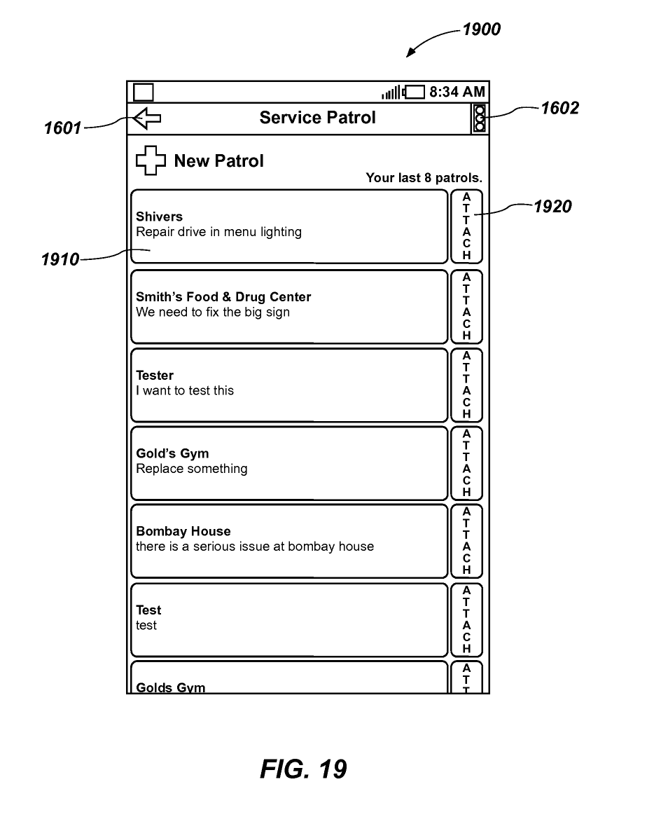

In FIG. 19, the GUI 1900 may be presented to the service patroller as the new service patrol entry screen of the application after the new service patrol entry information of FIG. 18 was saved. As a result, the information from FIG. 18 shows up as a service patrol entry 1910 and a corresponding attachment button 1920 at the top of the list of service patrol entries.

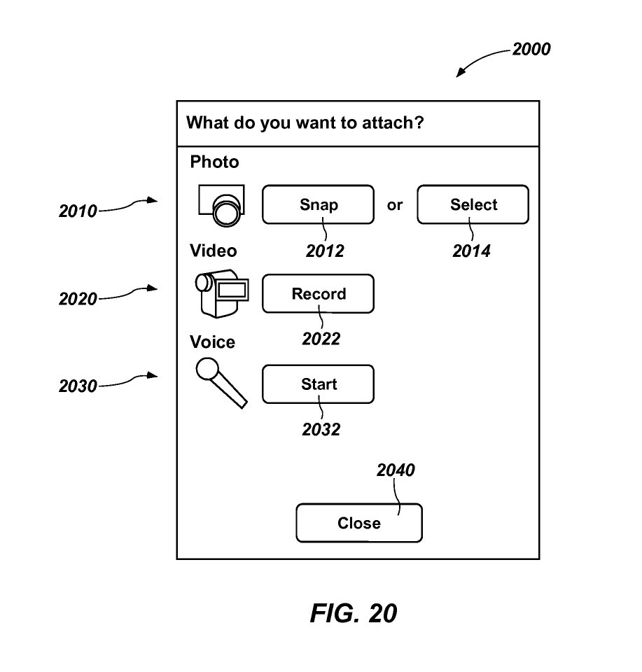

In FIG. 20, the GUI 2000 may be presented to the service patroller as the media attachment screen of the application responsive to the service patroller selecting one of the attachment buttons (e.g., attachment button 1920) of FIG. 19. The media attachment screen enables the service patroller to attach image 2010, video 2020, and audio 2030 files that are associated with the service patrol entry. For example, it may be desirable to have a picture of the sign outage so that a technician can see the sign and asses the problem prior to arrival to perform the service, which may result in time and cost savings by having the appropriate tools and parts. In addition, the image file may be provided to the customer or potential customer associated with the sales lead so that they are aware of the problem and the need for the service, which may increase the likelihood of that the business elects for the service to be performed. The image files may be taken on the spot by pressing the snap button 2012, or may be attached from a previously taken photo stored on the mobile device by pressing the select button 2014. The photo for the image file may be taken using a built-in camera of the mobile device 110. Similarly, video files and audio files may be generated and attached by pressing the record button 2022 and the start button 2032, respectively. Video may be taken using a built-in video camera of the mobile device 110, and audio may be taken using a built-in microphone of the mobile device 110. The video and audio files may likewise assist a technician by providing a different form of information than just an image file or text description. The close button 2040 closes the GUI 2000, returning the service patroller to view the GUI 1900 of FIG. 19.

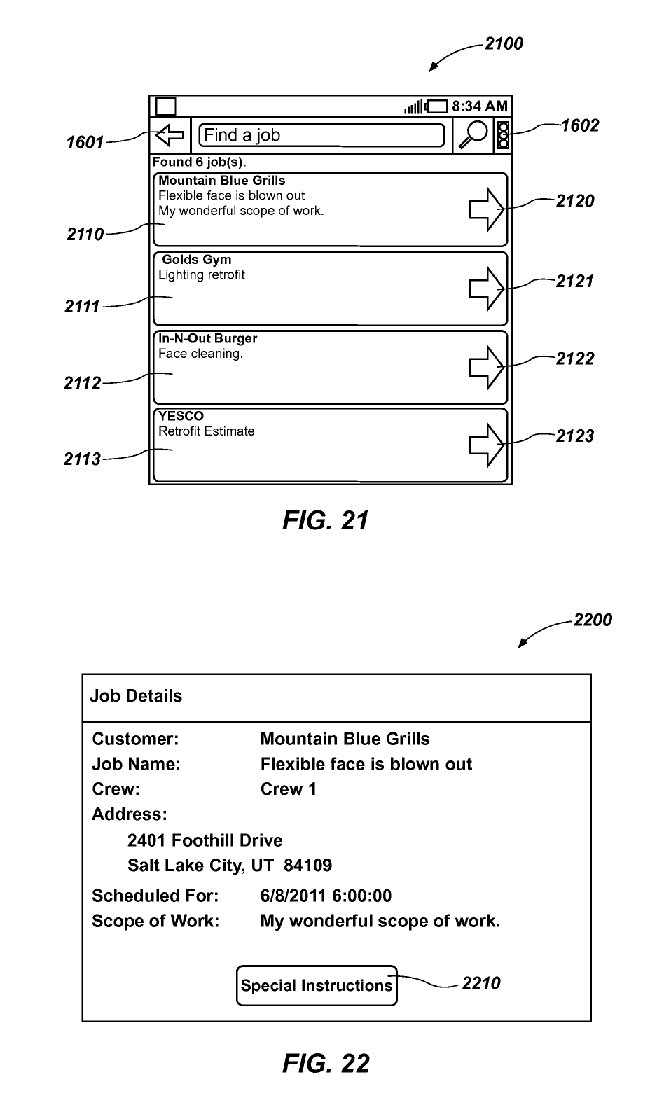

FIGS. 21 through 25 show a variety of GUIs 2100 through 2500 that may be employed for operating the mobile device 110 of FIG. 1 according to an embodiment of the present disclosure. In particular, the GUIs 2100 through 2500 may be accessible to service technicians to see record, and update information relating to their assigned jobs at the jobsite, as well as perform other tasks at the jobsite.

In FIG. 21, the GUI 2100 may be presented to the service technician as the jobs home screen of the application responsive to the service technician selecting the jobs icon 1640 of FIG. 16. The jobs home screen of the application displays a list of the scheduled jobs 2110, 2111, 2112, 2113 that have been assigned to the particular service technician logged into the application. As discussed above, the jobs 2110, 2111, 2112, 2113 may be assigned by the office personnel, and may be assigned to a particular crew. As a result, if a service technician is a member of two different crews, the service technician may see all jobs 2110, 2111, 2112, and 2113 that are assigned to each of the crews. As shown in FIG. 21, four jobs 2110, 2111, 2112, 2113 are displayed, each showing the customer and a brief description of the job. Selecting an individual job (e.g., job 2110) may cause another window to open showing additional details for that job. In addition, each job 2110, 2111, 2112, and 2113 may have a corresponding line item button 2120, 2121, 2122, 2123. Selecting one of the line item buttons 2120, 2121, 2122, and 2123 may open another window to show job line item details for the job.

In FIG. 22, the GUI 2200 may be presented to the service technician responsive to the service technician selecting the job 2110 of FIG. 21. As a result, the GUI 2200 displays additional job details, such as the address, crew, and scheduling information. In addition, special instructions related to that specific job or customer may be viewed by selecting a special instructions button 2210.

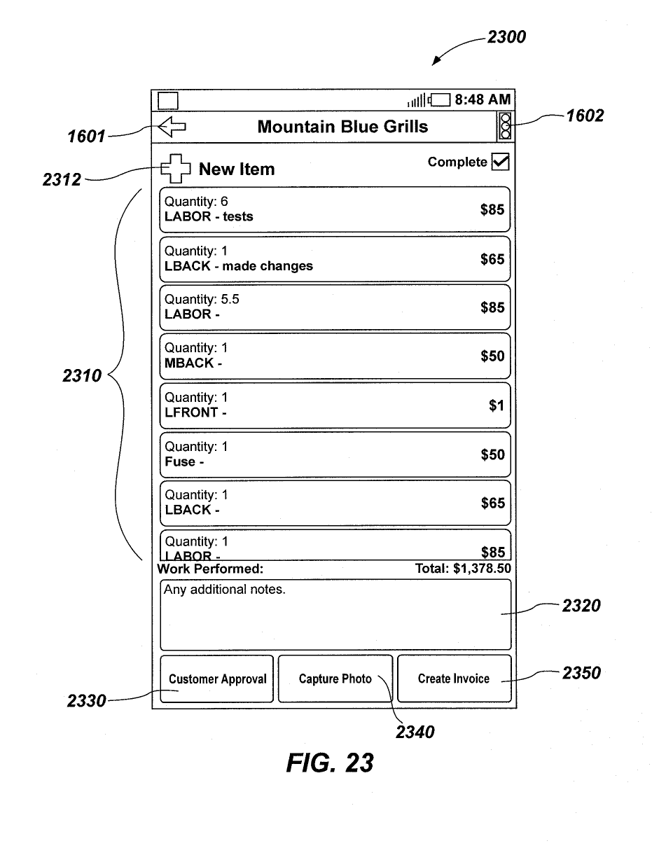

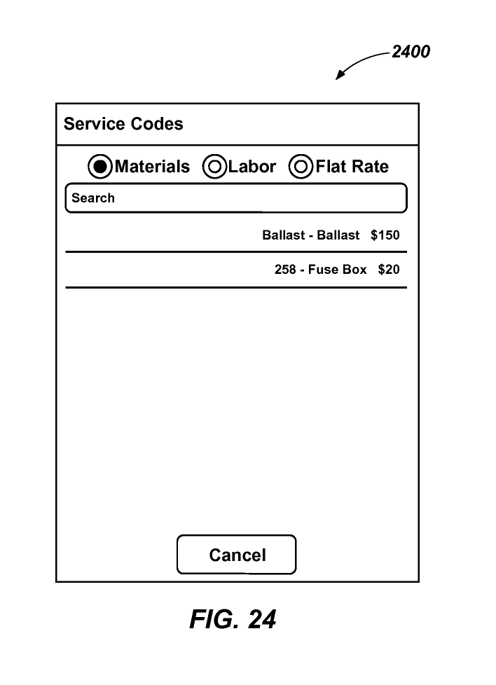

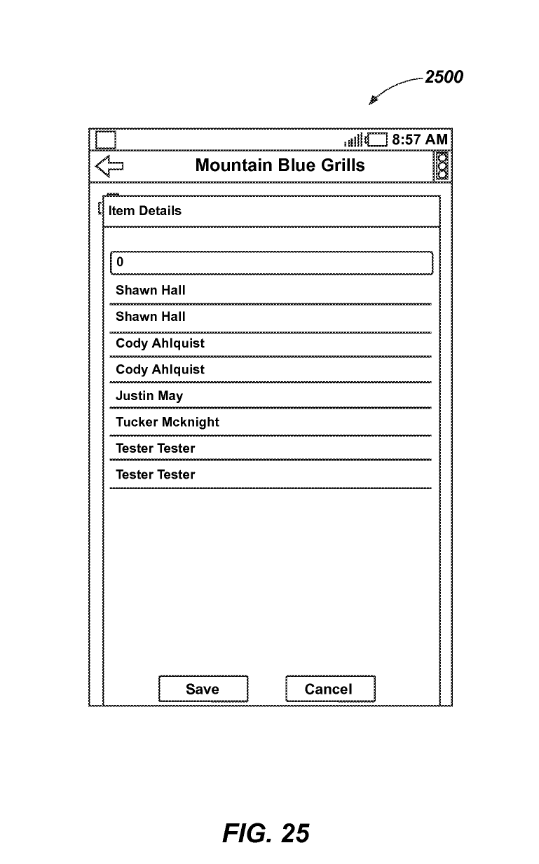

In FIG. 23, the GUI 2300 may be presented to the service technician responsive to the service technician selecting the line item button 2120 of FIG. 21. Job line items may be imported from the service codes resource. The GUI 2300 displays a list 2310 of the line items used to calculate the cost of the job. For example, the line items may include labor costs and parts costs, with each entry displaying a brief description and the associated cost. The GUI 2300 may further include an add new item button 2312 that opens a new window for adding a new line item for materials, labor, or a flat rate expense. This new window is shown as GUI 2400 in FIG. 24. FIG. 25 shows a GUI 2500 for entering hours worked for the various service technicians of the crew assigned to the particular job.

The GUI 2300 may further include a data entry field 2320 for including additional notes for the customer regarding the service performed. The GUI 2300 may further include buttons 2330, 2340, and 2350 for providing additional functionality for the service technician at the jobsite. For example, the customer approval button 2330 may be used to obtain customer approval of the service provided as well as the details on the list 2310 of line items for the service. The capture photo button 2340 may be used to capture one or more photos of the jobsite showing the finished job. The before photo and after photo may be used by office personnel for various purposes, such as to have a record of completion, to compare with each other for quality control, for future marketing campaigns, and to send to the customer for the customer's records. The create invoice button 2350 may be used to create an invoice on site, which may assist in the service technician collecting payment before arriving back at the office. The information entered at the jobsite by the service technician may be synchronized with the master database 122 as discussed above.

### CONCLUSION

In an embodiment, a sales lead generation system for a company in a service industry is disclosed. The sales lead generation system comprises a master database for storing information for customers of the company, and a mobile device for communicating sales lead information for service work to the master database. The sales lead information includes identifying information for the customers and at least one media file indicating an anomaly condition at a location of the customer.

In another embodiment, a method is disclosed for generating a sales lead for service work to be performed. The method comprises detecting an anomaly condition that is able to be remedied by the service work, and collecting information regarding the anomaly condition. The information may include customer information for locating the anomaly condition, and at least one image showing the anomaly condition. The method further comprises sending the information to a master database as sales lead information.

In another embodiment, a computer-readable storage media is disclosed. The computer-readable medium may store instructions that when executed by a processor cause the processor to perform instructions for generating a sales lead through a mobile device. The instructions may be configured for maintaining a master database storing data corresponding to a plurality of existing customers, receiving an image and a GPS location of the image, querying the master database by comparing the location of the image to locations associated with the plurality of existing customers, automatically generating a proposal to perform a service at the GPS location if the GPS location matches a location associated with one of the plurality of existing customers, and sending the proposal to perform the service for an entity located at that GPS location.

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents.

1. A sales lead generation system for a company in a service industry, the sales lead generation system comprising:
a master database for storing information for customers of the company; and
a mobile device for capturing and communicating sales lead information for service work to the master database, the sales lead information including identifying information for the customers and at least one media file indicating an anomaly condition at a location of the customer.

2. The sales lead generation system of claim 1, wherein the anomaly condition is at least one of an electrical anomaly condition and a physical anomaly condition of an electronic display.

3. The sales lead generation system of claim 1, wherein the at least one media file includes an image file showing the anomaly condition.

4. The sales lead generation system of claim 1, further comprising at least one remote computer configured to access the master database through an Internet-based platform.

5. The sales lead generation system of claim 4, wherein the at least one remote computer is configured to automatically generate a proposal for the service work responsive to the master database's reception of the sales lead information, wherein the proposal displays an image of the anomaly condition and the identifying information for the customer.

6. The sales lead generation system of claim 5, wherein the at least one remote computer is further configured to automatically transmit the proposal to the customer.

7. The sales lead generation system of claim 1, wherein the customer is an existing customer of the company that has not informed the company of the anomaly condition.

8. The sales lead generation system of claim 1, wherein the customer is a potential customer that is not currently an existing customer of the company.

9. The sales lead generation system of claim 1, wherein the mobile device and the master database are configured to synchronize at least some data with each other.

10. The sales lead generation system of claim 1, wherein the master database is configured to communicate job data to another mobile device for a service technician to remedy the anomaly condition after the job is accepted by the customer.

11. The sales lead generation system of claim 10, wherein the another mobile device is configured to communicate completed job data to the master database after completion of the job while the service technician remains at a jobsite for the job.

12. A method for generating a sales lead for service work to be performed, the method comprising:
detecting an anomaly condition that is able to be remedied by the service work;
collecting information regarding the anomaly condition, the information including customer information for locating the anomaly condition, and at least one image showing the anomaly condition; and
sending the information to a master database as sales lead information.

13. The method of claim 12, wherein collecting the information includes performing an online look up search to obtain the customer information based on global positioning system data received while detecting the anomaly condition.

14. The method of claim 12, wherein collecting the information includes entering the information into a graphical user interface of a mobile device that synchronizes a local data entry stored on the mobile device with the master database.

15. The method of claim 12, further comprising generating a sales lead form displaying the customer information and the at least one image.

16. The method of claim 12, further comprising scheduling an appointment for a service technician to remedy the anomaly condition.

17. A computer-readable storage media storing instructions that when executed by a processor cause the processor to perform instructions for generating a sales lead through a mobile device, the instructions configured for:
maintaining a master database storing data corresponding to a plurality of existing customers;
receiving an image and a global positioning system (GPS) location of the image;
querying the master database by comparing the location of the image to locations associated with the plurality of existing customers;
automatically generating a proposal to perform a service at the GPS location if the GPS location matches a location associated with one of the plurality of existing customers; and
sending the proposal to perform the service for an entity located at that GPS location.

18. The computer-readable medium of claim 17, wherein sending the proposal includes sending the proposal electronically to a customer contact email saved in the master database.

19. The computer-readable medium of claim 17, wherein maintaining the master database includes synchronizing the master database with a local database maintained by a mobile device.

20. The computer-readable medium of claim 17, wherein the instructions are further configured for providing an Internet-based platform for users to access the master database through a graphical user interface.

21. The computer-readable medium of claim 20, wherein the graphical user interface provides an interface for a user to create a job schedule if the proposal is accepted.
